(19) United States
(12) Patent Application Publication
(10) Pub. No.: US 2024/0401949 A1
(43) Pub. Date: Dec. 5, 2024

(54) SENSOR AND ELECTRONIC DEVICE

(71) Applicant: KABUSHIKI KAISHA TOSHIBA, Tokyo (JP)

(72) Inventors: Hideaki MURASE, Yokohama Kanagawa (JP); Yasushi TOMIZAWA, Fuchu Tokyo (JP); Daiki ONO, Yokohama Kanagawa (JP); Fumito MIYAZAKI, Yokohama Kanagawa (JP); Kengo UCHIDA, Kawasaki Kanagawa (JP); Kei MASUNISHI, Kawasaki Kanagawa (JP); Etsuji OGAWA, Kawasaki Kanagawa (JP); Jumpei OGAWA, Kawasaki Kanagawa (JP); Fumitaka ISHIBASHI, Sumida Tokyo (JP)

(73) Assignee: KABUSHIKI KAISHA TOSHIBA, Tokyo (JP)

(21) Appl. No.: 18/424,030

(22) Filed: Jan. 26, 2024

(30) Foreign Application Priority Data
Jun. 1, 2023 (JP) 2023-090993

(51) Int. Cl. G01C 19/5769

(52) U.S. Cl. CPC G01C 19/5769

(57) ABSTRACT

According to one embodiment, a sensor includes an element section. The element section includes a base, a first fixed portion, a first intermediate connect portion, a first intermediate movable member, a first connect portion, a first movable member, and a first fixed electrode. The first fixed portion is fixed to the base. The first intermediate connect portion is supported by the first fixed portion. The first intermediate movable member is connected to the first intermediate connect portion. The first connect portion is connected to the first intermediate movable member. The first movable member is supported by the first connect portion. The first movable member includes a first movable electrode. The first fixed electrode is fixed to the base and faces the first movable electrode.

### CROSS-REFERENCE TO RELATED APPLICATIONS

This application is based upon and claims the benefit of priority from Japanese Patent Application No. 2023-090993, filed on Jun. 1, 2023; the entire contents of which are incorporated herein by reference.

### FIELD

Embodiments described herein relate generally to a sensor, and an electronic device.

### BACKGROUND

For example, there are sensors using MEMS (Micro Electro Mechanical Systems) elements. It is desired to improve the characteristics of sensors.

### BRIEF DESCRIPTION OF THE DRAWINGS

FIG. 1 is a schematic plan view illustrating a sensor according to a first embodiment;

FIGS. 2A to 2D are schematic plan views illustrating a part of the sensor according to the first embodiment;

FIGS. 3A and 3B are schematic cross-sectional views illustrating the sensor according to the first embodiment;

FIGS. 4A and 4B are schematic cross-sectional views illustrating a sensor according to the first embodiment;

FIG. 5 is a schematic plan view illustrating a sensor according to the first embodiment;

FIG. 6 is a schematic plan view illustrating a sensor according to the first embodiment;

FIG. 7 is a schematic plan view illustrating a sensor according to the first embodiment;

FIG. 8 is a schematic cross-sectional view illustrating a sensor according to the first embodiment;

FIG. 9 is a schematic diagram illustrating an electronic device according to a second embodiment; and

FIGS. 10A to 10H are schematic views illustrating applications of the electronic device.

### DETAILED DESCRIPTION

According to one embodiment, a sensor includes an element section. The element section includes a base, a first fixed portion, a first intermediate connect portion, a first intermediate movable member, a first connect portion, a first movable member, and a first fixed electrode. The first fixed portion is fixed to the base. The first intermediate connect portion is supported by the first fixed portion. The first intermediate movable member is connected to the first intermediate connect portion. The first connect portion is connected to the first intermediate movable member. The first movable member is supported by the first connect portion. The first movable member includes a first movable electrode. The first fixed electrode is fixed to the base and faces the first movable electrode. A first gap is provided between the base and the first intermediate connect portion, between the base and the first intermediate movable member, between the base and the first connect portion, and between the base and the first movable member.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

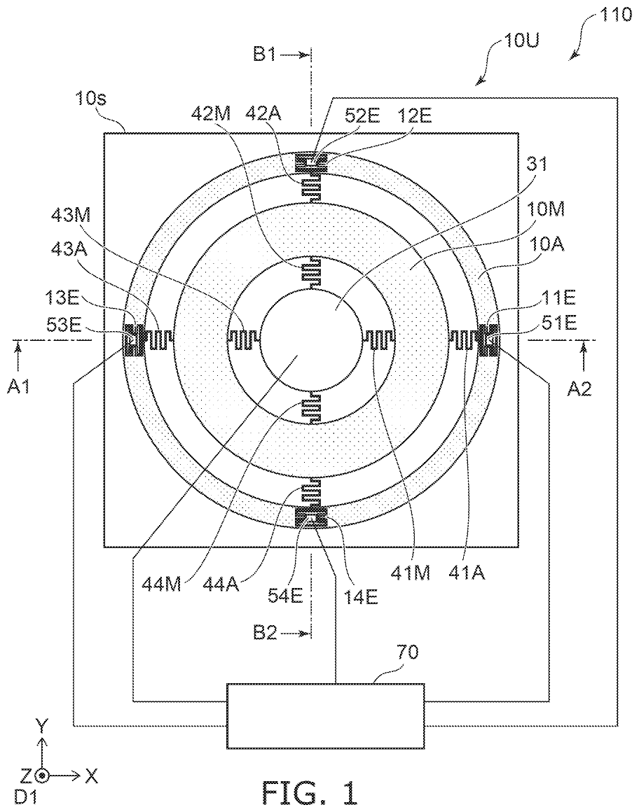

FIG. 1 is a schematic plan view illustrating a sensor according to a first embodiment.

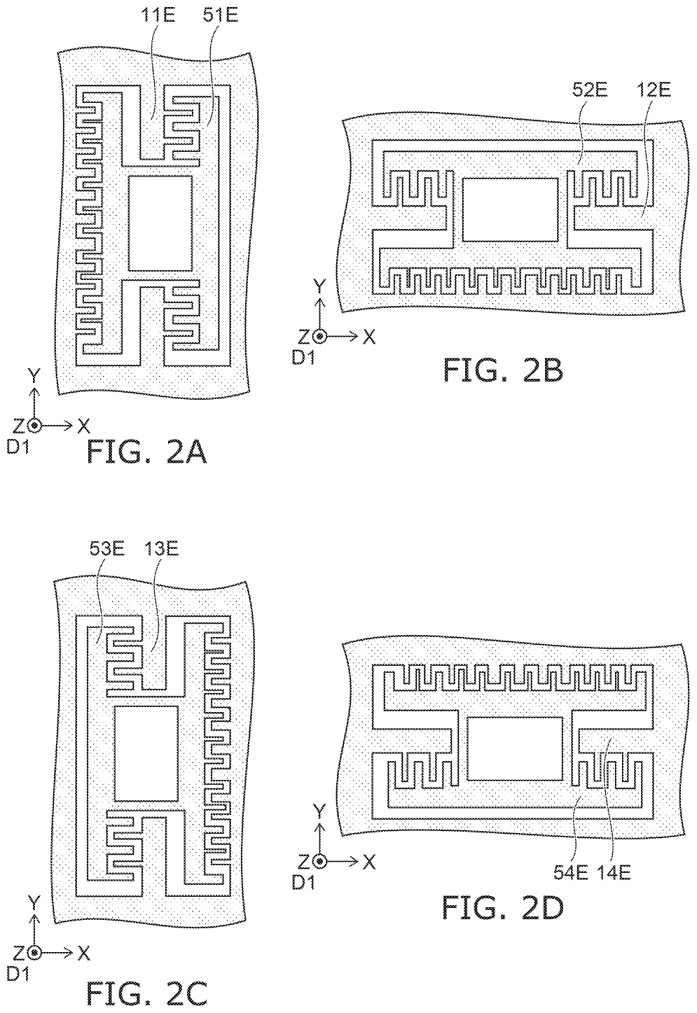

FIGS. 2A to 2D are schematic plan views illustrating a part of the sensor according to the first embodiment.

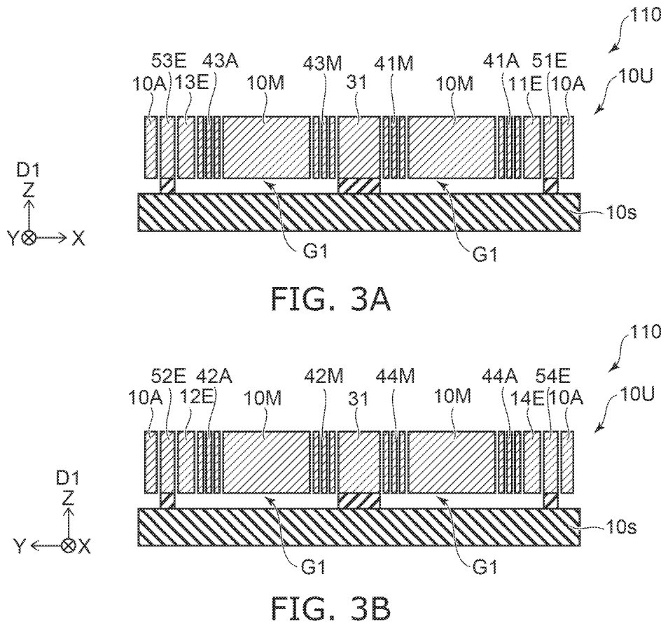

FIGS. 3A and 3B are schematic cross-sectional views illustrating the sensor according to the first embodiment.

FIG. 3A is a sectional view taken along the line A1-A2 in FIG. 1. FIG. 3B is a sectional view taken along the line B1-B2 in FIG. 1.

As shown in FIG. 1, a sensor 110 according to the embodiment includes an element section 10U. The element section 10U includes a base 10s, a first fixed portion 31, a first intermediate connect portion 41M, a first intermediate movable member 10M, a first connect portion 41A, a first movable member 10A, and a first fixed electrode 51E.

As shown in FIGS. 3A and 3B, the first fixed portion 31 is fixed to the base 10s. A first direction D1 from the base 10s to the first fixed portion 31 is defined as a Z-axis direction. One direction perpendicular to the Z-axis direction is defined as an X-axis direction. A direction perpendicular to the Z-axis direction and the X-axis direction is defined as a Y-axis direction.

The base 10s is along the X-Y plane. The base 10s may be, for example, a silicon substrate. The surface of the base 10s may be insulating. An insulating layer may be provided on the surface of the base 10s.

The first intermediate connect portion 41M is supported by the first fixed portion 31. The first intermediate movable member 10M is connected to the first intermediate connect portion 41M. The first connect portion 41A is connected to the first intermediate movable member 10M. The first movable member 10A is supported by the first connect portion 41A.

For example, the first intermediate connect portion 41M is provided between the first fixed portion 31 and the first intermediate movable member 10M. The first connect portion 41A is provided between the first intermediate movable member 10M and the first movable member 10A.

As shown in FIG. 3A, a first gap G1 is provided between the base 10s and the first intermediate connect portion 41M, between the base 10s and the first intermediate movable member 10M, between the base 10s and the first connect portion 41A, and between the base 10s and the first movable member 10A.

The first movable member 10A includes a first movable electrode 11E. The first fixed electrode 51E is fixed to the base 10s (see FIG. 3A). The first fixed electrode 51E faces the first movable electrode 11E. For example, the first movable electrode 11E and the first fixed portion 31 are electrically conductive. The first movable electrode 11E is electrically connected to the first fixed portion 31. FIG. 2A illustrates the first movable electrode 11E and the first fixed electrode 51E.

For example, a controller 70 may be provided. The controller 70 applies a signal between the first movable electrode 11E and the first fixed electrode 51E to vibrate the first movable member 10A. In this example, the signal is applied between the first movable electrode 11E and the first fixed electrode 51E via the first fixed portion 31. The signal includes an alternating component. A signal of the first movable member 10A based on the signal includes, for example, a component in the X-axis direction.

When the first movable member 10A is vibrating, an external force (e.g., angular velocity) is applied to the element section 10U. As a result, a component in another direction (for example, the Y-axis direction) is generated in the signal from the first movable member 10A. This is based on the Coriolis force, for example. The vibration state of the first movable member 10A changes depending on the external force. In the embodiment, the external force can be detected by detecting the change in the vibration state of the first movable member 10A. The sensor 110 is, for example, a gyro sensor.

The first fixed portion 31 is, for example, an anchor. The first movable member 10A is a proof mass. The first movable member 10A is connected to the first fixed portion 31 by a connect portion. Thereby, the first movable member 10A is supported apart from the base 10s.

For example, the first intermediate connect portion 41M and the first connect portion 41A have a meandering structure. The first intermediate connect portion 41M and the first connect 5 portion 41A are, for example, springs.

In the embodiment, the first intermediate movable member 10M is provided between the first intermediate connect portion 41M and the first connect portion 41A. Thereby, more stable vibration can be obtained.

For example, the force of vibration based on the vibration of the first movable member 10A is transmitted toward the first fixed portion 31. For example, it has been found that in a reference example in which only a spring connect portion is provided between the first movable member 10A and the first 15 fixed portion 31, vibration tends to become unstable.

In contrast, in the embodiment, the first intermediate movable member 10M is provided at the connect portion provided between the first movable member 10A and the first fixed portion 31. By providing the first intermediate movable member 10M, the vibration force based on the vibration of the first movable member 10A is alleviated by the first intermediate movable member 10M. The vibration force based on the vibration of the first movable member 10A is suppressed from being transmitted toward the first fixed portion 31. Thereby, more stable vibration can be obtained. Detection with higher accuracy becomes possible. According to the embodiment, it is possible to provide a sensor whose characteristics can be improved.

As will be described below, for example, when the element section 10U is provided in a housing or the like, vibrations based on the vibrations of the first movable member 10A are easily transmitted toward the first fixed portion 31 via the wall of the housing or the like. By providing the first intermediate movable member 10M, stable vibration can be maintained even in such a case. Thereby, higher precision detection can be performed. According to the embodiment, it is possible to provide a sensor whose characteristics can be improved.

A first plane crossing the first direction D1 from the base 10s to the first fixed portion 31 corresponds to the XY-plane. As shown in FIG. 1, in this example, the first intermediate movable member 10M is provided around the first fixed portion 31 in the first plane (X-Y plane). In the first plane, the first movable member 10A is provided around the first intermediate movable member 10M.

In this example, the first intermediate movable member 10M is annular. The first movable member 10A is annular.

As shown in FIGS. 1 and 3B, in this example, the element section 10U further includes a second intermediate connect portion 42M and a second connect portion 42A. The second intermediate connect portion 42M is connected to the first fixed portion 31. A part of the first intermediate movable member 10M is connected to the second intermediate connect portion 42M. A part of the second connect portion 42A is connected to the first intermediate movable member 10M. Another part of the second connect portion 42A is connected to the first movable member 10A. The first gap G1 is further provided between the base 10s and the second intermediate connect portion 42M and between the base 10s and the second connect portion 42A.

As shown in FIGS. 1 and 3A, in this example, the element section 10U further includes a third intermediate connect portion 43M and a third connect portion 43A. The third intermediate connect portion 43M is connected to the first fixed portion 31. A part of the first intermediate movable member 10M is connected to the third intermediate connect portion 43M. A part of the third connect portion 43A is connected to the first intermediate movable member 10M. Another part of the third connect portion 43A is connected to the first movable member 10A. The first gap G1 is further provided between the base 10s and the third intermediate connect portion 43M and between the base 10s and the third connect portion 43A.

As shown in FIGS. 1 and 3B, in this example, the element section 10U further includes a fourth intermediate connect portion 44M and a fourth connect portion 44A. The fourth intermediate connect portion 44M is connected to the first fixed portion 31. A part of the first intermediate movable member 10M is connected to the fourth intermediate connect portion 44M. A part of the fourth connect portion 44A is connected to the first intermediate movable member 10M. Another part of the fourth connect portion 44A is connected to the first movable member 10A. The first gap G1 is further provided between the base 10s and the fourth intermediate connect portion 44M and between the base 10s and the fourth connect portion 44A.

As shown in FIGS. 1 and 3B, in this example, the element section 10U further includes a second fixed electrode 52E. The second fixed electrode 52E is fixed to the base 10s. The first movable member 10A includes a second movable electrode 12E. The second fixed electrode 52E faces the second movable electrode 12E. A direction from the first fixed portion 31 to the second fixed electrode 52E crosses the direction from the first fixed portion 31 to the first fixed electrode 51E. FIG. 2B illustrates the second movable electrode 12E and the second fixed electrode 52E.

As shown in FIGS. 1 and 3A, in this example, the element section 10U further includes a third fixed electrode 53E. The third fixed electrode 53E is fixed to the base 10s. The first movable member 10A includes a third movable electrode 13E. The third fixed electrode 53E faces the third movable electrode 13E. In this example, a direction from the first fixed portion 31 to the third fixed electrode 53E is along the direction from the first fixed portion 31 to the first fixed electrode 51E. FIG. 2C illustrates the third movable electrode 13E and the third fixed electrode 53E.

As shown in FIGS. 1 and 3B, in this example, the element section 10U further includes a fourth fixed electrode 54E. The fourth fixed electrode 54E is fixed to the base 10s. The first movable member 10A includes a fourth movable electrode 14E. The fourth fixed electrode 54E faces the fourth movable electrode 14E. In this example, a direction from the first fixed portion 31 to the fourth fixed electrode 54E is along the direction from the first fixed portion 31 to the second fixed electrode 52E. FIG. 2D illustrates the fourth movable electrode 14E and the fourth fixed electrode 54E.

The first fixed electrode 51E, the second fixed electrode 52E, the third fixed electrode 53E, and the fourth fixed electrode 54E may be electrically connected to the controller 70. The first movable electrode 11E, the second movable electrode 12E, the third movable electrode 13E, and the fourth movable electrode 14E may be electrically connected to the controller 70 via the first fixed portion 31, for example.

For example, the first fixed electrode 51E and the first movable electrode 11E form a comb-teeth electrode pair. For example, the second fixed electrode 52E and the second movable electrode 12E form another comb-teeth electrode pair. For example, the third fixed electrode 53E and the third movable electrode 13E form another comb-teeth electrode pair. For example, the fourth fixed electrode 54E and the fourth movable electrode 14E form another comb-teeth electrode pair.

By applying signals to these electrode pairs, the first movable member 10A can be vibrated in any direction. Vibration may be generated by one pair of electrodes, and the state of vibration may be detected by another pair of electrodes.

For example, vibration including a component in the X-axis direction may be obtained by the first fixed electrode 51E and the first movable electrode 11E. For example, vibration including a component in the Y-axis direction may be obtained by the second fixed electrode 52E and the second movable electrode 12E. For example, by the third fixed electrode 53E and the third movable electrode 13E, a component in the X-axis direction may be detected as the vibration state. For example, by the fourth fixed electrode 54E and the fourth movable electrode 14E, a component in the Y-axis direction may be detected as the vibration state.

In the embodiment, the state of vibration may be detected by other methods (for example, methods using light, etc.).

In the embodiment, a mass of the first intermediate movable member 10M is greater than a mass of the connect portion (for example, a spring). Thereby, the vibration force based on the vibration of the first movable member 10A is suppressed from being transmitted toward the first fixed portion 31. Stable vibration can be obtained.

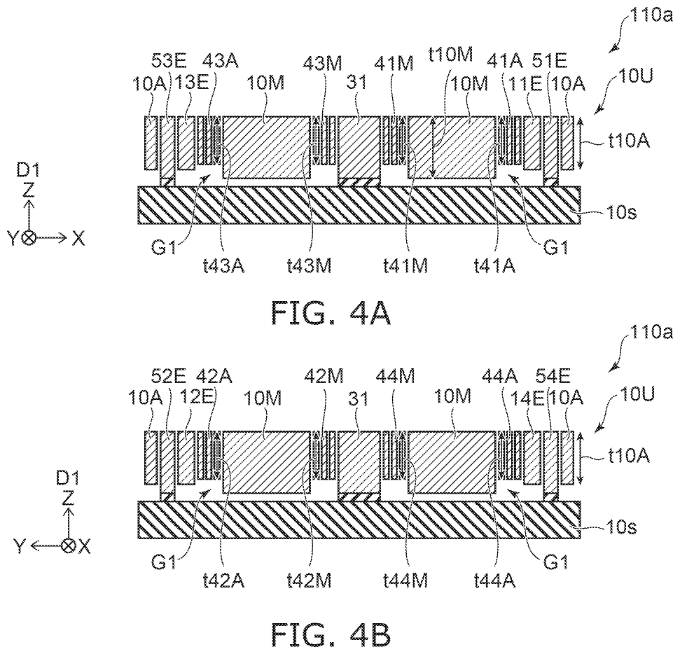

For example, the first intermediate movable member 10M and the first intermediate connect portion 41M satisfy at least one of a first condition, a second condition, a third condition, or a fourth condition. In the first condition, a mass of the first intermediate movable member 10M is greater than a mass of the first intermediate connect portion 41M. In the second condition, an area of the first intermediate movable member 10M is larger than an area of the first intermediate connect portion 41M (see FIG. 1). In the third condition, a thickness of the first intermediate movable member 10M is thicker than a thickness of the first intermediate connect portion 41M (see FIG. 4A) described below). In the fourth condition, a density of the first intermediate movable member 10M is higher than a density of the first intermediate connect portion 41M. In such conditions, unnecessary transmission of vibration can be suppressed more reliably.

For example, the first intermediate movable member 10M and the first connect portion 41A satisfy at least one of a fifth condition, a sixth condition, a seventh condition, or an eighth condition. In the fifth condition, the mass of the first intermediate movable member 10M is larger than a mass of the first connect portion 41A. In the sixth condition, the area of the first intermediate movable member 10M is larger than an area of the first connect portion 41A. In the seventh condition, the thickness of the first intermediate movable member 10M is thicker than a thickness of the first connect portion 41A (see FIG. 4A described below). In the eighth condition, the density of the first intermediate movable member 10M is higher than a density of the first connect portion 41A. In such conditions, unnecessary transmission of vibration can be suppressed more reliably.

In the embodiment, it is preferable that the first intermediate movable member 10M and the first movable member 10A satisfy at least one of a ninth condition, a tenth condition, an eleventh condition, or a twelfth condition. In the ninth condition, the mass of the first intermediate movable member 10M is greater than a mass of the first movable member 10A. In the tenth condition, the area of the first intermediate movable member 10M is larger than an area of the first movable member 10A. In the eleventh condition, the thickness of the first intermediate movable member 10M is thicker than a thickness of the first movable member 10A (see FIG. 4A described below). In the twelfth condition, the density of the first intermediate movable member 10M is higher than a density of the first movable member 10A. In such conditions, unnecessary transmission of vibration can be suppressed more reliably.

FIGS. 4A and 4B are schematic cross-sectional views illustrating a sensor according to the first embodiment.

These figures are sectional views corresponding to the sectional views taken along the A1-A2 line and taken along the B1-B2 line in FIG. 1.

As shown in these figures, in a sensor 110a according to the embodiment, the thicknesses of at least two structures included in the element section 10U are different from each other. Except for this, the configuration of the sensor 110a may be the same as the configuration of the sensor 110.

As shown in FIG. 4A, in this example, the thickness t10M of the first intermediate movable member 10M is thicker than the thickness t41M of the first intermediate connect portion 41M. The thickness t10M of the first intermediate movable member 10M is thicker than the thickness t41A of the first connect portion 41A. The thickness t10M of the first intermediate movable member 10M is thicker than the thickness t10A of the first movable member 10A.

As shown in FIG. 4A, in this example, the thickness t10M of the first intermediate movable member 10M is thicker than the thickness t43M of the third intermediate connect portion 43M. The thickness t10M of the first intermediate movable member 10M is thicker than the thickness t43A of the third connect portion 43A.

As shown in FIG. 4B, in this example, the thickness t10M of the first intermediate movable member 10M is thicker than the thickness t42M of the second intermediate connect portion 42M. The thickness t10M of the first intermediate movable member 10M is thicker than the thickness t42A of the second connect portion 42A. In this example, the thickness t10M of the first intermediate movable member 10M is thicker than the thickness t44M of the fourth intermediate connect portion 44M. The thickness t10M of the first intermediate movable member 10M is thicker than the thickness t44A of the fourth connect portion 44A.

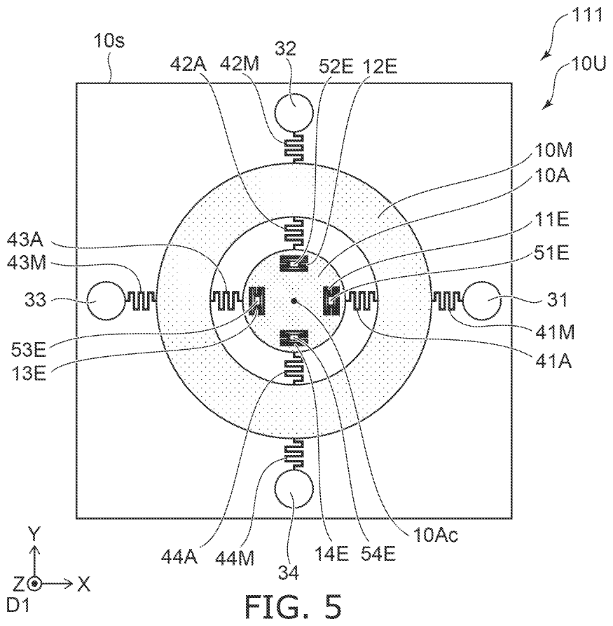

FIG. 5 is a schematic plan view illustrating a sensor according to the first embodiment.

As shown in FIG. 5, in a sensor 111 according to the embodiment, the configuration of the element section 10U is different from the configuration of the element section 10U in the sensor 110. The configuration of sensor 110 can be applied to sensor 111 except for the parts described below.

In the sensor 111, the first intermediate movable member 10M is annular. In a first plane (X-Y plane) crossing the first direction D1, the first intermediate movable member 10M is provided around the first movable member 10A. The first fixed portion 31 is provided outside the first intermediate movable member 10M. In the sensor 111, by providing the first intermediate movable member 10M, transmission of the vibration force based on the vibration of the first movable member 10A toward the first fixed portion 31 is suppressed. Stable vibration can be obtained.

In this example, the element section 10U includes a second fixed portion 32, a second intermediate connect portion 42M, and a second connect portion 42A. The second fixed portion 32 is fixed to the base 10s. The second intermediate connect portion 42M is connected to the second fixed portion 32. A part of the first intermediate movable member 10M is connected to the second intermediate connect portion 42M. A part of the second connect portion 42A is connected to the first intermediate movable member 10M. Another part of the second connect portion 42A is connected to the first movable member 10A. The first gap G1 is further provided between the base 10s and the second intermediate connect portion 42M and between the base 10s and the second connect portion 42A (see FIG. 3B).

The element section 10U includes a third fixed portion 33, a third intermediate connect portion 43M, and a third connect portion 43A. The third fixed portion 33 is fixed to the base 10s. The third intermediate connect portion 43M is connected to the third fixed portion 33. A part of the first intermediate movable member 10M is connected to the third intermediate connect portion 43M. A part of the third connect portion 43A is connected to the first intermediate movable member 10M.

The element section 10U includes a fourth fixed portion 34, a fourth intermediate connect portion 44M, and a fourth connect portion 44A. The fourth fixed portion 34 is fixed to the base 10s. The fourth intermediate connect portion 44M is connected to the fourth fixed portion 34. A part of the first intermediate movable member 10M is connected to the fourth intermediate connect portion 44M. A part of the fourth connect portion 44A is connected to the first intermediate movable member 10M.

In the sensor 111, the second fixed portion 32, the third fixed portion 33, and the fourth fixed portion 34 are provided outside the first intermediate movable member 10M.

In the sensor 111, the element section 10U may further include a second fixed electrode 52E, a third fixed electrode 53E, a fourth fixed electrode 54E, and the like. The second fixed electrode 52E faces the second movable electrode 12E. The third fixed electrode 53E faces the third movable electrode 13E. The fourth fixed electrode 54E faces the fourth movable electrode 14E.

A direction from the center 10Ac of the first movable member 10A to the second fixed electrode 52E in the first plane (X-Y plane) crosses a direction from the center 10Ac to the first fixed electrode 51E. A direction from the center 10Ac of the first movable member 10A to the third fixed electrode 53E in the first plane (X-Y plane) is along the direction from the center 10Ac to the first fixed electrode 51E. A direction from the center 10Ac of the first movable member 10A to the fourth fixed electrode 54E in the first plane (X-Y plane) is along the direction from the center 10Ac to the second fixed electrode 52E.

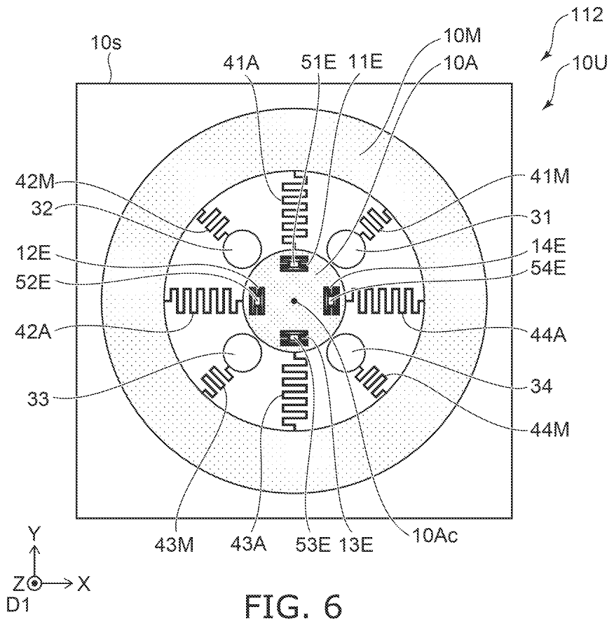

FIG. 6 is a schematic plan view illustrating a sensor according to the first embodiment.

As shown in FIG. 6, in a sensor 112 according to the embodiment, the configuration of the element section 10U is different from the configuration of the element section 10U in the sensor 110. The configuration of the sensor 110 can be applied to the sensor 112, except as described below.

In the sensor 112, the first intermediate movable member 10M is annular. In the first plane (X-Y plane) crossing the first direction D1, the first intermediate movable member 10M is provided around the first movable member 10A. The first fixed portion 31 is provided inside the first intermediate movable member 10M. In the sensor 112, by providing the first intermediate movable member 10M, transmission of the vibration force based on the vibration of the first movable member 10A toward the first fixed portion 31 is suppressed. Stable vibration can be obtained.

In the sensor 112, the element section 10U includes the second fixed portion 32, the second intermediate connect portion 42M, and the second connect portion 42A. The second fixed portion 32 is fixed to the base 10s. The second intermediate connect portion 42M is connected to the second fixed portion 32. A part of the first intermediate movable member 10M is connected to the second intermediate connect portion 42M. A part of the second connect portion 42A is connected to the first intermediate movable member 10M. Another part of the second connect portion 42A is connected to the first movable member 10A. The first gap G1 is further provided between the base 10s and the second intermediate connect portion 42M and between the base 10s and the second connect portion 42A (see FIG. 3B).

In the sensor 112, the second fixed portion 32, the third fixed portion 33, and the fourth fixed portion 34 may be provided. In the sensor 112, the second fixed portion 32, the third fixed portion 33, and the fourth fixed portion 34 are provided inside the first intermediate movable member 10M.

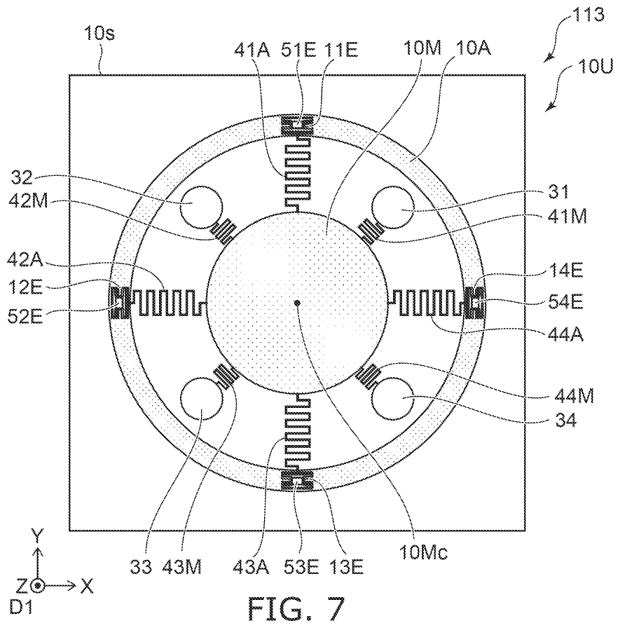

FIG. 7 is a schematic plan view illustrating a sensor according to the first embodiment.

As shown in FIG. 7, in a sensor 113 according to the embodiment, the configuration of the element section 10U is different from the configuration of the element section 10U in the sensor 110. The configuration of sensor 110 can be applied to sensor 113 except for the parts described below.

In the sensor 113, the first movable member 10A is annular. In the first plane (X-Y plane) crossing the first direction D1, the first movable member 10A is provided around the first intermediate movable member 10M. The first fixed portion 31 is provided inside the first movable member 10A. In the sensor 113, by providing the first intermediate movable member 10M, transmission of the vibration force based on the vibration of the first movable member 10A toward the first fixed portion 31 is suppressed. Stable vibration can be obtained.

In the sensor 113, the element section 10U includes the second fixed portion 32, the second intermediate connect portion 42M, and a second connect portion 42A. The second fixed portion 32 is fixed to the base 10s. The second intermediate connect portion 42M is connected to the second fixed portion 32. A part of the first intermediate movable member 10M is connected to the second intermediate connect portion 42M. A part of the second connect portion 42A is connected to the first intermediate movable member 10M. Another part of the second connect portion 42A is connected to the first movable member 10A. The first gap G1 is further provided between the base 10s and the second intermediate connect portion 42M and between the base 10s and the second connect portion 42A (see FIG. 3B).

In the sensor 113, the element section 10U may further include the second fixed electrode 52E, the third fixed electrode 53E, the fourth fixed electrode 54E, and the like. The second fixed electrode 52E faces the third movable electrode 13E. The third fixed electrode 53E faces the third movable electrode 13E. The fourth fixed electrode 54E faces the fourth movable electrode 14E.

A direction from the center 10Mc of the first intermediate movable member 10M to the second fixed electrode 52E in the first plane (X-Y plane) crosses the direction from the center 10Mc to the first fixed electrode 51E. A direction from the center 10Mc of the first intermediate movable member 10M to the third fixed electrode 53E in the first plane (X-Y plane) is along the direction from the center 10Mc to the first fixed electrode 51E. A direction from the center 10Mc of the first intermediate movable member 10M to the fourth fixed electrode 54E in the first plane (X-Y plane) is along the direction from the center 10Mc to the second fixed electrode 52E.

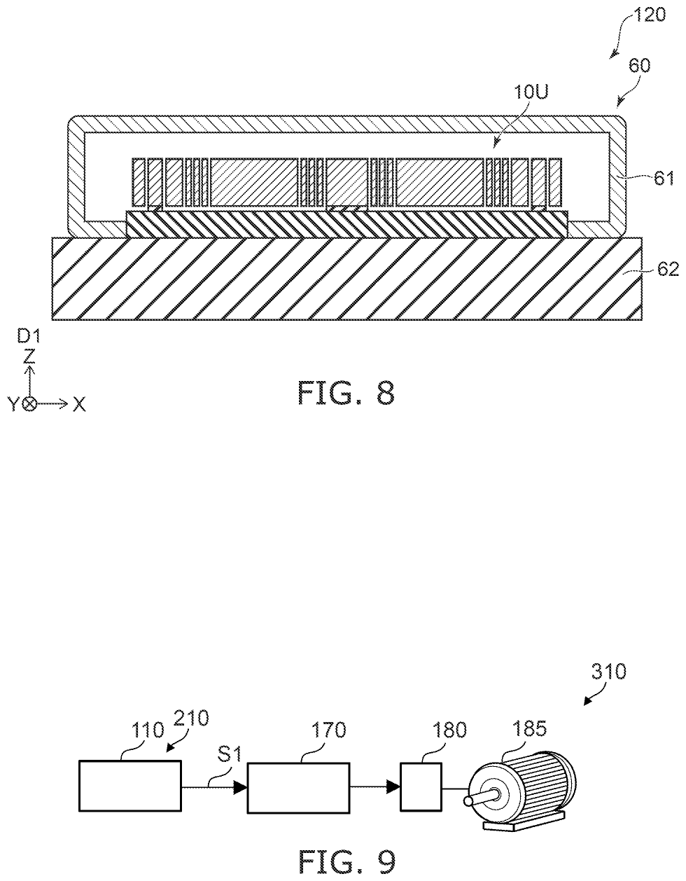

FIG. 8 is a schematic cross-sectional view illustrating a sensor according to the first embodiment.

As shown in FIG. 8, a sensor 120 according to the embodiment further includes a housing 60 in addition to the element section 10U. The element section 10U is provided inside the housing 60. The inside of the housing 60 may be depressurized. The pressure in the space inside the housing 60 is lower than 1 atmosphere.

In this example, the housing 60 includes a circuit board 62 and a case 61. The element section 10U is provided between the circuit board 62 and a lid portion of the case 61. The circuit board 62 may include at least a part of the controller 70.

As in the example of FIG. 8, when the element section 10U is provided in a housing or the like, vibrations based on the vibrations of the first movable member 10A may be transmitted to the housing via the first fixed portion 31. A part of the transmitted vibration may be reflected by the housing and transmitted to the first movable member 10A via the first fixed portion 31 again. By providing the first intermediate movable member 10M, stable vibration can be maintained even in such a case. A sensor with improved characteristics can be provided.

### Second Embodiment

The second embodiment relates to an electronic device.

FIG. 9 is a schematic diagram illustrating an electronic device according to a second embodiment.

As shown in FIG. 9, an electronic device 310 according to the embodiment includes the sensors according to the first to third embodiments and the circuit processor 170. In the example of FIG. 9, the sensor 110 (or the sensor device 210) is drawn as the sensor. The circuit processor 170 is configured to control a circuit 180 based on the signal S1 obtained from the sensor. The circuit 180 is, for example, a control circuit for a drive device 185. According to the embodiment, for example, the circuit 180 for controlling the drive device 185 can be controlled with high accuracy.

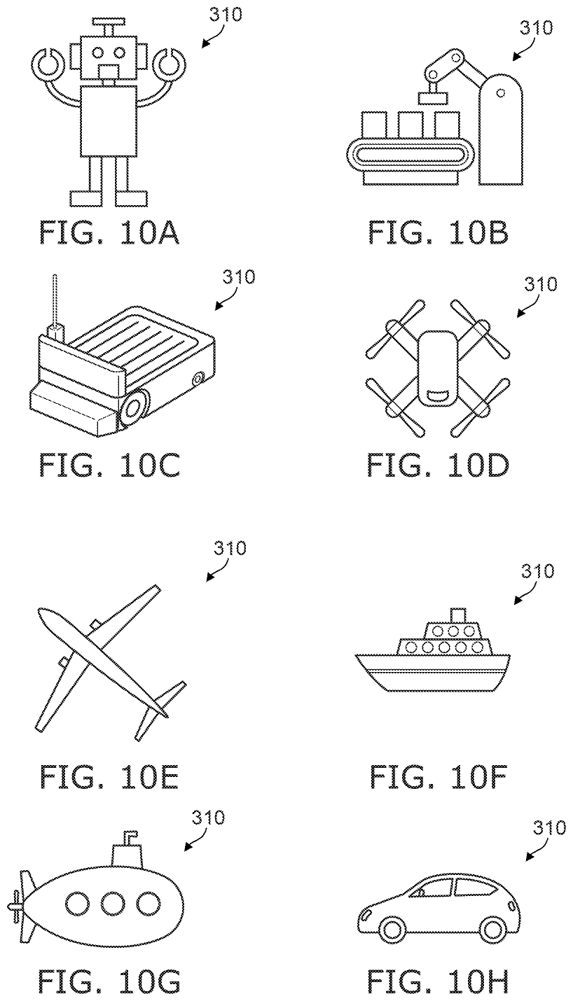

FIGS. 10A to 10H are schematic views illustrating applications of the electronic device.

As shown in FIG. 10A, the electronic device 310 may be at least a portion of a robot. As shown in FIG. 10B, the electronic device 310 may be at least a portion of a machining robot provided in a manufacturing plant, etc. As shown in FIG. 10C, the electronic device 310 may be at least a portion of an automatic guided vehicle inside a plant, etc. As shown in FIG. 10D, the electronic device 310 may be at least a portion of a drone (an unmanned aircraft). As shown in FIG. 10E, the electronic device 310 may be at least a portion of an airplane. As shown in FIG. 10F, the electronic device 310 may be at least a portion of a ship. As shown in FIG. 10G, the electronic device 310 may be at least a portion of a submarine. As shown in FIG. 10H, the electronic device 310 may be at least a portion of an automobile. The electronic device 310 may include, for example, at least one of a robot or a moving body.

The embodiments may include the following Configurations (e.g., technical proposals):

### Configuration 1

A sensor, comprising:
an element section,
the element section including
   a base,
   a first fixed portion fixed to the base,
   a first intermediate connect portion supported by the first fixed portion,
   a first intermediate movable member connected to the first intermediate connect portion,
   a first connect portion connected to the first intermediate movable member,
   a first movable member supported by the first connect portion, the first movable member including a first movable electrode, and
   a first fixed electrode fixed to the base and facing the first movable electrode,
a first gap being provided between the base and the first intermediate connect portion, between the base and the first intermediate movable member, between the base and the first connect portion, and between the base and the first movable member.

### Configuration 2

The sensor according to Configuration 1, wherein
the first intermediate movable member and the first intermediate connect portion satisfy at least one of a first condition, a second condition, a third condition, or the fourth condition,
in the first condition, a mass of the first intermediate movable member is greater than a mass of the first intermediate connect portion,
in the second condition, an area of the first intermediate movable member is larger than an area of the first intermediate connect portion,
in the third condition, a thickness of the first intermediate movable member is thicker than a thickness of the first intermediate connect portion, and
in the fourth condition, a density of the first intermediate movable member is higher than ae density of the first intermediate connect portion.

### Configuration 3

The sensor according to Configuration 2, wherein
the first intermediate movable member and the first connect portion satisfy at least one of a fifth condition, a sixth condition, a seventh condition, or an eighth condition,
in the fifth condition, the mass of the first intermediate movable member is greater than a mass of the first connect portion,
in the sixth condition, the area of the first intermediate movable member is larger than an area of the first connect portion,
in the seventh condition, the thickness of the first intermediate movable member is thicker than a thickness of the first connect portion, and
in the eighth condition, the density of the first intermediate movable member is higher than a density of the first connect portion.

### Configuration 4

The sensor according to Configuration 2 or 3, wherein
the first intermediate movable member and the first movable member satisfy at least one of a ninth condition, a tenth condition, an eleventh condition, or a twelfth condition,
in the ninth condition, the mass of the first intermediate movable member is greater than a mass of a first movable member,
in the tenth condition, the area of the first intermediate movable member is larger than an area of the first movable member,
in the eleventh condition, the thickness of the first intermediate movable member is thicker than a thickness of the first movable member, and
in the twelfth condition, the density of the first intermediate movable member is higher than a density of the first movable member.

### Configuration 5

The sensor according to any one of Configurations 1-4, wherein
the first intermediate movable member is provided around the first fixed portion in a first plane crossing a first direction from the base to the first fixed portion, and
the first movable member is provided around the first intermediate movable member in the first plane.

### Configuration 6

The sensor according to Configuration 5, wherein
the first intermediate movable member is annular, and
the first movable member is annular.

### Configuration 7

The sensor according to Configuration 6, wherein
the element section further includes
   a second intermediate connect portion, and
   a second connect portion,
the second intermediate connect portion is connected to the first fixed portion,
a part of the first intermediate movable member is connected to the second intermediate connect portion,
a part of the second connect portion is connected to the first intermediate movable member,
another part of the second connect portion is connected to the first movable member, and
the first gap is further provided between the base and the second intermediate connect portion, and between the base and the second connect portion.

### Configuration 8

The sensor according to any one of Configurations 1-4, wherein
the first intermediate movable member is annular,
the first intermediate movable member is provided around the first movable member in a first plane crossing a first direction from the base to the first fixed portion, and
the first fixed portion is provided outside the first intermediate movable member.

### Configuration 9

The sensor according to Configuration 8, wherein
the element section further includes
   a second fixed portion provided at the base,
   a second intermediate connect portion connected to the second fixed, and
   a second connect portion,
a part of the first intermediate movable member is connected to the second intermediate connect portion,
a part of the second connect portion is connected to the first intermediate movable member,
another part of the second connect portion is connected to the first movable member, and
the first gap is further provided between the base and the second intermediate connect portion, and between the base and the second connect portion.

### Configuration 10

The sensor according to any one of Configurations 1-4, wherein
the first intermediate movable member is annular,
the first intermediate movable member is provided around the first movable member in a first plane crossing a first direction from the base to the first fixed portion, and
the first fixed portion is provided inside the first intermediate movable member.

### Configuration 11

The sensor according to Configuration 10, wherein
the element section further includes
   a second fixed portion provided on the base,
   a second intermediate connect portion connected to the second fixed portion, and
   a second connect portion,
a part of the first intermediate movable member is connected to the second intermediate connect portion,
a part of the second connect portion is connected to the first intermediate movable member,
another part of the second connect portion is connected to the first movable member, and
the first gap is further provided between the base and the second intermediate connect part and between the base and the second connect portion.

### Configuration 12

The sensor according to any one of Configurations 1-4, wherein
the first movable member is annular,
the first movable member is provided around the first intermediate movable member in a first plane crossing a first direction from the base to the first fixed portion, and
the first fixed portion is provided inside the first movable member.

### Configuration 13

The sensor according to Configuration 12, wherein
the element section further includes
   a second fixed portion provided on the base,
   a second intermediate connect portion connected to the second fixed portion, and
   a second connect portion,
a part of the first intermediate movable member is connected to the second intermediate connect portion,
a part of the second connect portion is connected to the first intermediate movable member,
another part of the second connect portion is connected to the first movable member, and
the first gap is further provided between the base and the second intermediate connect portion and between the base and the second connect portion.

### Configuration 14

The sensor according to any one of Configurations 1-6, wherein
the element section further includes a third fixed electrode fixed to the base,
the first movable member includes a third movable electrode,
the third fixed electrode faces the third movable electrode, and
a direction from the first fixed portion to the third fixed electrode is along a direction from the first fixed portion to the first fixed electrode.

### Configuration 15

The sensor according to any one of Configurations 8-11, wherein
the element section further includes a third fixed electrode fixed to the base,
the first movable member includes a third movable electrode,
the third fixed electrode faces the third movable electrode, and
a direction from a center of the first movable member to the third fixed electrode on the first plane is along a direction from the center to the first fixed electrode.

### Configuration 16

The sensor according to Configuration 12 or 13, wherein
the element section further includes a third fixed electrode fixed to the base,
the first movable member includes a third movable electrode,
the third fixed electrode faces the third movable electrode, and
a direction from a center of the first intermediate movable member to the third fixed electrode on the first plane is along a direction from the center to the first fixed electrode.

### Configuration 17

The sensor according to any one of Configurations 1-16, wherein
the first intermediate connect portion and the first connect portion have a meander structure.

### Configuration 18

The sensor according to any one of Configurations 1-17, further comprising:
a housing,
the element section being provided inside the housing.

### Configuration 19

An electronic device, comprising:
the sensor according to any one of Configurations 1-18; and
a circuit controller configured to control a circuit based on a signal obtained from the sensor.

### Configuration 20

The electronic device according to Configuration 19, wherein
the electronic device includes at least one of a robot and a moving object.

According to the embodiment, a sensor and an electronic device with improved characteristics can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the sensor such as element sections, bases, fixed portions, connect portions, movable members, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors and all electronic devices practicable by an appropriate design modification by one skilled in the art based on the sensors and the electronic devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
an element section,
the element section including
a base,
a first fixed portion fixed to the base,
a first intermediate connect portion supported by the first fixed portion,
a first intermediate movable member connected to the first intermediate connect portion,
a first connect portion connected to the first intermediate movable member,
a first movable member supported by the first connect portion, the first movable member including a first movable electrode, and
a first fixed electrode fixed to the base and facing the first movable electrode,
a first gap being provided between the base and the first intermediate connect portion, between the base and the first intermediate movable member, between the base and the first connect portion, and between the base and the first movable member.

2. The sensor according to claim 1, wherein
the first intermediate movable member and the first intermediate connect portion satisfy at least one of a first condition, a second condition, a third condition, or the fourth condition,
in the first condition, a mass of the first intermediate movable member is greater than a mass of the first intermediate connect portion,
in the second condition, an area of the first intermediate movable member is larger than an area of the first intermediate connect portion,
in the third condition, a thickness of the first intermediate movable member is thicker than a thickness of the first intermediate connect portion, and
in the fourth condition, a density of the first intermediate movable member is higher than ae density of the first intermediate connect portion.

3. The sensor according to claim 2, wherein
the first intermediate movable member and the first connect portion satisfy at least one of a fifth condition, a sixth condition, a seventh condition, or an eighth condition,
in the fifth condition, the mass of the first intermediate movable member is greater than a mass of the first connect portion,
in the sixth condition, the area of the first intermediate movable member is larger than an area of the first connect portion,
in the seventh condition, the thickness of the first intermediate movable member is thicker than a thickness of the first connect portion, and
in the eighth condition, the density of the first intermediate movable member is higher than a density of the first connect portion.

4. The sensor according to claim 2, wherein
the first intermediate movable member and the first movable member satisfy at least one of a ninth condition, a tenth condition, an eleventh condition, or a twelfth condition,
in the ninth condition, the mass of the first intermediate movable member is greater than a mass of a first movable member,
in the tenth condition, the area of the first intermediate movable member is larger than an area of the first movable member,
in the eleventh condition, the thickness of the first intermediate movable member is thicker than a thickness of the first movable member, and
in the twelfth condition, the density of the first intermediate movable member is higher than a density of the first movable member.

5. The sensor according to claim 1, wherein
the first intermediate movable member is provided around the first fixed portion in a first plane crossing a first direction from the base to the first fixed portion, and
the first movable member is provided around the first intermediate movable member in the first plane.

6. The sensor according to claim 5, wherein
the first intermediate movable member is annular, and
the first movable member is annular.

7. The sensor according to claim 6, wherein
the element section further includes
a second intermediate connect portion, and
a second connect portion,
the second intermediate connect portion is connected to the first fixed portion,
a part of the first intermediate movable member is connected to the second intermediate connect portion,
a part of the second connect portion is connected to the first intermediate movable member,
another part of the second connect portion is connected to the first movable member, and
the first gap is further provided between the base and the second intermediate connect portion, and between the base and the second connect portion.

8. The sensor according to claim 1, wherein
the first intermediate movable member is annular,
the first intermediate movable member is provided around the first movable member in a first plane crossing a first direction from the base to the first fixed portion, and
the first fixed portion is provided outside the first intermediate movable member.

9. The sensor according to claim 8, wherein
the element section further includes
a second fixed portion provided at the base,
a second intermediate connect portion connected to the second fixed, and
a second connect portion,
a part of the first intermediate movable member is connected to the second intermediate connect portion,
a part of the second connect portion is connected to the first intermediate movable member,
another part of the second connect portion is connected to the first movable member, and
the first gap is further provided between the base and the second intermediate connect portion, and between the base and the second connect portion.

10. The sensor according to claim 1, wherein
the first intermediate movable member is annular,
the first intermediate movable member is provided around the first movable member in a first plane crossing a first direction from the base to the first fixed portion, and
the first fixed portion is provided inside the first intermediate movable member.

11. The sensor according to claim 10, wherein
the element section further includes
a second fixed portion provided on the base,
a second intermediate connect portion connected to the second fixed portion, and
a second connect portion,
a part of the first intermediate movable member is connected to the second intermediate connect portion,
a part of the second connect portion is connected to the first intermediate movable member,
another part of the second connect portion is connected to the first movable member, and
the first gap is further provided between the base and the second intermediate connect part and between the base and the second connect portion.

12. The sensor according to claim 1, wherein
the first movable member is annular,
the first movable member is provided around the first intermediate movable member in a first plane crossing a first direction from the base to the first fixed portion, and
the first fixed portion is provided inside the first movable member.

13. The sensor according to claim 12, wherein
the element section further includes
a second fixed portion provided on the base,
a second intermediate connect portion connected to the second fixed portion, and
a second connect portion,
a part of the first intermediate movable member is connected to the second intermediate connect portion,
a part of the second connect portion is connected to the first intermediate movable member,
another part of the second connect portion is connected to the first movable member, and
the first gap is further provided between the base and the second intermediate connect portion and between the base and the second connect portion.

14. The sensor according to claim 1, wherein
the element section further includes a third fixed electrode fixed to the base,
the first movable member includes a third movable electrode,
the third fixed electrode faces the third movable electrode, and
a direction from the first fixed portion to the third fixed electrode is along a direction from the first fixed portion to the first fixed electrode.

15. The sensor according to claim 8, wherein
the element section further includes a third fixed electrode fixed to the base,
the first movable member includes a third movable electrode,
the third fixed electrode faces the third movable electrode, and
a direction from a center of the first movable member to the third fixed electrode on the first plane is along a direction from the center to the first fixed electrode.

16. The sensor according to claim 12, wherein
the element section further includes a third fixed electrode fixed to the base,
the first movable member includes a third movable electrode,
the third fixed electrode faces the third movable electrode, and
a direction from a center of the first intermediate movable member to the third fixed electrode on the first plane is along a direction from the center to the first fixed electrode.

17. The sensor according to claim 1, wherein
the first intermediate connect portion and the first connect portion have a meander structure.

18. The sensor according to claim 1, further comprising:
a housing,
the element section being provided inside the housing.

19. An electronic device, comprising:
the sensor according to claim 1; and
a circuit controller configured to control a circuit based on a signal obtained from the sensor.

20. The electronic device according to claim 19, wherein
the electronic device includes at least one of a robot and a moving object.
